(19) United States
(12) Patent Application Publication
(10) Pub. No.: US 2006/0137404 A1
(43) Pub. Date: Jun. 29, 2006

(54) Method for manufacturing glass rod

(75) Inventors: Tomohiro Nunome, Sakura-shi (JP); Naritoshi Yamada, Sakura-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIKURA LTD.

(21) Appl. No.: 11/313,617

(22) Filed: Dec. 22, 2005

(30) Foreign Application Priority Data
Dec. 28, 2004 (JP) P2004-380307

(51) Int. Cl. C03B 37/018

(52) U.S. Cl. 65/421; 65/531

(57) ABSTRACT

A method for manufacturing a glass rod includes introducing a glass source material gas, an inert gas, a flammable gas, and a combustion assisting gas to a multi-tube burner, where the multi-tube burner includes a first multi-tube, a plurality of nozzles provided surrounding the first multi-tube about a central axis of the first multi-tube and a second multi-tube provided surrounding the nozzles, where the first multi-tube and the second multi-tube have a common central axis; hydrolyzing or oxidizing the glass source material gas in a flame generated by a reaction between the flammable gas and the combustion assisting gas to synthesize glass microparticles; and depositing the glass microparticles on the outer periphery portion of the starting rod in a radial direction to manufacture the glass rod, wherein a ratio of a flow rate A of the flammable gas to a flow rate B of the combustion assisting gas (A/B) satisfies the following inequality: 2.5≦A/B≦4.5.

### BACKGROUND OF THE INVENTION

1. Field of the Invention

The pet invention relates to a method for manfaucturing a glass rod, in particular, to a method for manufacturing a glass rod applicable to the outside vapor phase deposition technique in which a glass source material gas is reacted in a flame produced by a reaction between a flammable gas and a combustion assisting gas to synthesize glass microparticles, and the resulting glass microparticles are effectively deposited on the outer periphery portion of a starting rod in the radial direction.

Priority is claimed on Japanese Patent Application No. 2004-380307, filed Dec. 28, 2004, the contents of which are incorporated herein by reference.

2. Description of the Related Art

Conventionally, for manufacturing optical fiber preforms, methods are generally employed in which porous optical fiber preforms fabricated using soot methods, such as the outside vapor phase deposition (OVD) method or the vapor-phase axial deposition (VAD) method, are treated at a high temperature.

In order to manufacture such silica porous preforms, two ends of a staring rod having a glass material to form a core of an optical fiber, are held by holding devices and the starting rod is rotated around the axis thereof.

Then, a glass source material gas, such as silicon tetrachloride (SiCl₄), germanium tetrachloride (GeCl₄), or the like, is jetted from one or more glass synthesizing burners together with a flammable gas, such as hydrogen or the like, and a combustion assisting gas, such as oxygen or the like, such that the glass source material gas is hydrolyzed or oxidize in a flame generated by a reaction between the flammable gas and the combustion assisting gas to synthesize glass microparticles. The glass microparticles are deposited on the outer periphery portion of the stating rod rotated around the axis in the radial direction to obtain a porous optical fiber preform.

In recent years, the sizes of optical fiber preforms have been increased in order to reduce the cost of manufacturing optical fibers. As a result, the sizes of porous optical fiber preforms manufactured by soot methods, typified by the OVD method, tend to be increased. In order to reduce the manufacturing cost, this increase in the size calls for reduction in the time required for manufacturing. To achieve this, the deposition rate of glass microparticles on the outer periphery portion of the starting rod should be increased.

As a technique to increase the deposition rate, a technique was proposed in which a ratio of flow rates of oxyhydrogen flame gases introduced into a multi-tube burner is optimized in order to increase the deposition rate (see Japanese Unexamined Patent Application, First Publication, No. H10-330129, for example).

It is considered that a mechanism of the deposition of glass microparticles described above is largely affected by the thermophoresis effect. The term “thermophoresis effect” refers to a phenomenon in which microparticles migrate from a higher temperature region to a lower temperature region in the presence of a heat gradient where the microparticles are present. In order to increase the deposition rate on the outer periphery portion of the starting rod by means of this effect, a temperature gradient must be set between the starting rod and the glass microparticles or in the flame.

It should be noted that many glass microparticles must be present near the outer periphery portion of the starting rod in order to deposit glass microparticles by means of the thermophoresis effect.

However, the conventional method achieved by optimizing the ratio of flow rates of oxyhydrogen flame gases suffers from a shortcoming since the increase in the deposition rate of glass microparticles on the outer periphery portion of the starting rod is not sufficient.

This method specifies an optimum ratio of flow rates of gases when a multi-tube burner is used and the more outside a tube is located, the larger the cross-sectional area of the channel of the tube becomes and thus the lower the flow velocity of a gas flowing through the tube is. When the flow velocities of gases become too low, the convergence of a flame is decreased. Thus, the more outside a tube is located, the higher the flow velocity of a gas flowing through the tube is required to be by increasing a flow rate of the gas so that the flow velocity is maintained, thereby stabilizing the flame. However, increasing the flow rate of a gas is not desirable from the viewpoints of manuring cost and capacity of the heat exhaust.

Furthermore, when the convergence of a flame is reduced, the flame becomes more susceptible to external disturbances, such as exhaust. As a result, the flame may fluctuate or become unstable. The effect of the fluctuation of the flame tends to be intensified when a preform for an optical fiber is fabricated while a plurality of multi-tube burners are shifted. This may cause cracks in the optical fiber preform as well as a reduction in the deposition rate, which may result in reduced productivity of optical fiber preforms.

In order to maintain the flow velocity of the gas without causing a reduction in the flow rate of the gas, a multi nozzle-type burner has been proposed in which the cross-sectional area of a gas channel of each nozzle is reduced by arranging a plurality of nozzles in the same plane. Such a burner is often designed so that the pluarlity of nozzles are arranged so that they form a focus, and this design is advantageous in that such a focus improves the convergence of the flame, and desired thermal power and stability of the flame can be ensure with a small amount of oxyhydrogen. However, this structure is greatly different from the so-called “multi-tube burner,” and know-how of the so-called “multi-tube burner” cannot be simply applied to the multi nozzle-type burner.

Optimum conditions for jetting the gas from such a multi nozzle-type burner have yet to be found.

The present invention was conceived in view of the above-mentioned background, and an object thereof is to provide a method for manufacturing a glass rod which can increase the deposition rate of glass microparticles onto the outer periphery portion of the starting rod, and accordingly, can efficiently produce glass rods, such as optical fiber preforms, without degrading quality.

### SUMMARY OF THE INVENTION

In order to solve the above identified problems, the present invention provides the following aspects.

That is, a first aspect of the present invention is a method for manufacturing a glass rod, comprising: introducing a glass source material gas, an inert gas, a flammable gas, and a combustion assisting gas to a multi-tube borer, the multi-tube burner comprising a first multi-tube; a plurality of nozzles provided surrounding the first multi-tube about a central axis of the first multi-tube; and a second multi-tube provided surrounding the nozzles, wherein the first multi-tube and the second multi-tube have a common central axis; hydrolyzing or oxidizing the glass source material gas in a flame generated by a reaction between the flammable gas and the combustion assisting gas to synthesize glass microparticles; and depositing the glass microparticles on the outer periphery portion of the starting rod in a radial direction to manufacture the glass rod, wherein a ratio of a flow rate A of the flammable gas to a flow rate B of the combustion assisting gas (A/B) satisfies the following inequality:
2.5≦A/B≦4.5.

In a second aspect of the present invention, in the above method for manufacturing a glass rod, a ratio of a flow velocity V_{O} of the combustion assisting gas to a flow velocity of the glass source material gas V_{S} (V_{O}/V_{S}) may satisfy the following inequality: V_{O}(V_{S}≦0.9.

As used herein, the term “flow velocity V_{O} of the combustion assisting gas” mean the flow velocity of a combustion assisting gas jetted from a plurality of nozzles that are arranged such that they form a focus, and the term “the flow velocity of the glass source material gas V_{S}” means a flow velocity of a glass source material gas (e.g., SiCl₄), or, when the carrier gas is used, a value calculated from the total flow rat of the glass source material gas and the carrier gas.

In a third aspect of the present invention, the above method for manufacturing a glass rod may fit comprise treating the glass microparticles deposited in the radial direction on the outer periphery portion of the starting rod at a high temperature to form a glass body.

In a fourth aspect of the present invention, in the above method for manufacturing a glass rod, the first multi-tube may comprise concentric tubes or a plurality of elliptic-sped tubes having a central axis.

In a fifth aspect of the present invention, in the above method for manufacturing a glass rod, the plurality of nozzles may be arranged on at least one circle having a center that matches the central axis of the first multi-tube.

According to the method for manufacturing a glass rod according to the present invention, since the ratio of the flow rate A of the flammable gas to the flow rate B of the combustion assisting gas (A/B) is controlled to satisfy the following inequality: 2.5≦A/B≦4.5, it is possible to increase the deposition rate of glass microparticles in the radial direction to the outer periphery portion of the starting rod by setting the flow rate A of the flammable gas and the flow rate B of the combustion assisting gas in a multi-tube burner to appropriate ranges. Accordingly, it becomes possible to efficiently manufacture large-diameter glass rods without ring deteriorated quality, and accordingly, glass rods, such as optical fibers, can be provided at low cost.

### BRIEF DESCRIPTION OF THE DRAWINGS

FIG. 1 is a plan view illustrating an example of an end portion of a multi-tube burner used in a method for manufacturing a glass rod according to an embodiment of the present invention;

FIG. 2 is a plan view illustrating another example of an end portion of a multi-tube burner used in a method for manufacturing a glass rod according to an embodiment of the present invention;

FIG. 3 is a graph showing the relationship between the ratio of the flow rate A of H₂/the flow rate B of O₂ and the deposition rate (g/minute); and

FIG. 4 is a graph showing the relationship between the ratio of flow velocity V_{O} of O₂/flow velocity V_{S} of SiCl₄ and the deposition rate (g/minute).

### DETAILED DESCRIPTION OF THE INVENTION

Hereinafter, a method for manufacturing a glass rod according to an embodiment of the present invention will be explained. It should be noted that this embodiment illustrates the spirit of the present invention in detail for ease of understanding, and that the present invention is not limited to is embodiment.

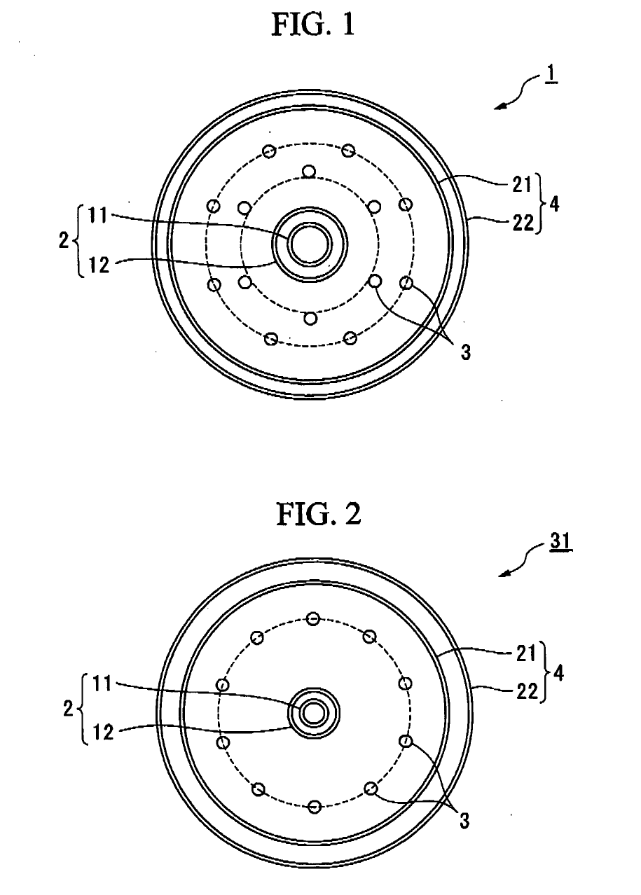

FIG. 1 is a plan view illustrating an example of an end of a multi-tube burner for synthesizing glass used in an apparatus for manufacturing glass rods used for the method for manufacturing a glass rod of this embodiment. In FIG. 1, reference numeral 1 denotes a multi-tube burner, and the multi-tube burner 1 comprises a first multi-tube 2, a plurality of nozzles 3, and a second multi-tube 4.

The first multi-tube 2 is constructed from an inner tube 11 having an outer diameter of between about 3 mm and 5 mm and an outer tube 12 having an outer diameter of between about 6 mm and 8 mm which is provided surrounding the inner tube 11 and has the same central axis as that of the inner tube 11. The inner tube 11 and the outer tube 12 am typically made of silica glass. The inner tube 11 is used as a channel for a glass source material gas, such as silicon tetrachloride (SiCl₄), germanium tetrachloride (GeCl₄), or the like, and the space between the inner tube 11 and the outer tube 12 is used as a channel for an inert gas, such as argon (Ar) gas, nitrogen (N₂) gas, or the like.

The nozzles 3 an provided around the first multi-tube 2 about the central axis of the first multi-tube 2. More specifically, six nozzles 3 are provided at regular intervals in the radial direction on a circumference having a radius of about 8 mm around the central axis of the first multi-tube 2, and eight nozzles 3 are provided at regular intervals in the radial direction on a circumference having a radius of about 12 mm. These nozzles 3 are topically made of silica glass. The nozzles 3 are used as channels of a combustion assisting gas such as oxygen (O₂) gas or the like.

The second multi-tube 4 is constructed from an inner tube 21 having an outer diameter of between about 25 mm and 30 mm and an outer tube 22 having an outer diameter of between about 30 mm and 35 mm which is provided surrounding the inner tube 21 and has the same central axis as that of the inner tube 21. The inner tube 21 and the outer tube 22 are typically made of silica glass. The inside of the inner tube 21 is used as a channel for a flammable gas, such as hydrogen (H₂) gas or the like, and the space between the inner tube 21 and the outer tube 22 is used as a channel for an inert gas, such as argon (Ar) gas, nitrogen (N₂) gas, or the like.

FIG. 2 is a plan view illustrating another example of an end of a multi-tube burner for synthesizing glass used in an apparatus for manufacturing glass rods used for the method for manufacturing a glass rod of this embodiment. A multi-tube burner 31 is different from the above-described multi-tube burner 1 in that ten nozzles 3 are provided at regular intervals in the radial direction on a circumference having a radius of about 7 mm around the central axis of the first multi-tube 2, the other structures being the same as those of the above multi-tube burner 1.

A method for manufacturing glass rods for optical fibers using a glass rod manufacturing that has the multi-tube burner 1 is described below.

First a column-shaped starting rod made of silica glass or the like is provided. The staring rod is then positioned horizontally in a predetermined position in the glass rod manufacturing, and he staring rod is rotated around the central axis thereof.

Next, one or more of the multi-tube burner 1 are positioned near the outer periphery surface of this rotating starting rod. A combustion assisting gas, such as oxygen (O₂) gas or the like, is jetted from the nozzles 3, a flammable gas, such as hydrogen (H₂) gas or the like, is jetted from the inside of the inner tube 21 of the second multi-tube 4, and an inert gas, such as nitrogen (N₂) gas or the like, is jetted from the space between 1be inner tube 21 and the outer tube 22. The flammable gas and the combustion assisting gas react on the outside of the end portion the multi-tube burner 1, which generates a flame, e.g., an oxyhydrogen flame.

Into this flame, a glass source material gas, such as silicon tetrachloride (SiCl₄), germanium tetrachloride (GeCl₄), or the like, is jetted from the inner tube 11 of the first multi-tube 2 and an inert gas, s as argon (Ar) gas, nitrogen (N₂) gas, or the like, is jetted from the space between the inner tube 11 and the outer tube 12, such that the glass source material gas is hydrolyzed or oxidized in the flame to synthesize glass particles. The glass particles are deposited on the outer periphery portion of the sag rod rotated around the axis in the radial direction.

In this process, the ratio of the flow rate of the flammable gas A to the flow rate of the combustion assisting gas B (A/B) should satisfy the following inequality:
2.5≦A/B≦4.5.

For example, when SiCl₄ gas, Ar gas, X gas, and O₂ gas are used as the glass source material gas, the inert gas, the flammable gas, and the combustion assisting gas, respectively, the reaction of the glass source material gas is the following hydrolysis and oxidation that occur simultaneously.
SiCl₄+2H₂O→SiO₂+4HCl (1)
SiCl₄+O₂→SiO₂+2Cl₂ (2)

The reaction ratio of H₂ gas to O₂ gas is theoretically 2:1 when it is assumed that the hydrolysis is dominant. However, the deposition rate of glass microparticles reaches the maximum value at the actual reaction ratio that is shifted from this theoretical reaction ratio.

When the relationship between the deposition rate of glass microparticles and the ratio of the flow rate of H₂ gas A to the flow rate of O₂ gas B (A/B) is actually determined, the deposition rate of glass microparticles reaches the maximum when the ratio A/B satisfies 2.5≦A/B≦4.5.

The above range is selected for the following reasons. If A/B≦2.5, the flame becomes less stable since the amount of oxygen not involved in the reaction is increased and glass microparticles generated cannot be directed to the outer periphery portion of the staring rod, winch results in a reduction in the deposition rate at the outer periphery portion of the sag rod. In contrast, if 4.5≦A/B, generation of glass microparticles is delayed due to a lack of oxygen, which results in a decrease in the deposition rate at the outer periphery portion of the stating rod.

Another exemplary range of the ratio A/B is 3.0≦A/B≦4.0, and when the ratio A/B falls within this range, the deposition rate of glass microparticles can be maintained stably.

When a plurality of gas flows are present in close vicinity, and, as into case of the multi-tube burner 1, some gas flows are affected by gas flows having high flow velocities. If the flow velocity of oxygen gas is higher than the flow velocity of the glass source material gas, the flow of the glass source material gas spreads extending beyond the flame and glass microparticles generated in the flame flow in the region distant from the outer periphery portion of the s rod. As a result the probability of glass microparticles being present in the vicinity of the outer periphery portion of the starting rod is deceased, resulting in a decrease in the deposition rate of glass microparticles.

When the relationship between the ratio of the flow the velocity of O₂ gas V_{O} to the flow the velocity of SiCl₄ gas V_{S} (V_{O}/V_{S}) and the deposition rate of glass miicroparticles is experimentally determined, the deposition rate of glass microparticles is increased when the ratio V_{O}/V_{S} satisfies V_{O}/V_{S}≦0.9. Another exemplary range of the ratio Vₒ/V_{S} is V_{O}/V_{S}≦0.7.

This is because when the flow velocity of SiCl₄ gas V_{S} is set to a higher value than the flow velocity of O₂ gas V_{O}, glass microparticles generated by hydrolysis or oxidation of the SiCl₄ gas are directed to the vicinity of the outer periphery portion of the starting rod while the glass microparticles are converged on the center of the flame. Thus, the deposition rate is increased because of a thermophoresis effect.

If 0.9<V_{O}V_{S}, the flow velocity of SiCl₄ gas V_{S} becomes smaller than the flow velocity of O₂ gas V_{O} and the flow of SiCl₄ gas spreads extending beyond the flame and glass microparticles generated by hydrolysis or oxidation of the SiCl₄ gas are directed to the vicinity of the outer periphery portion of the starting rod while drifting from the center of the flame. Therefore, the probability of glass microparticles being present in the vicinity of the outer periphery portion of the start rod is decreased, resulting in a decrease in the deposition rate of glass microparticles, which is undesirable.

Although the lower limit of the ratio V_{O}/V_{S} is not particularly limited, V_{O}/V_{S} of 0.1 or higher is considered exemplary since problems, such as noise from the burner, may occur when the flow velocity of SiCl₄ gas V_{S} greatly exceeds the flow velocity of O₂ gas V_{O}.

As described above, according to the method for manufacturing a glass rod of this embodiment, since the ratio of the flow rate A of the flammable gas to the flow rate B of the combustion assisting gas (A/B) is controlled to satisfy the following inequality: 2.5≦A/B≦4.5, it is possible to increase the deposition rate of glass microparticles in the radial direction to the outer periphery portion of the starting rod by setting the flow rate A of the flammable gas and the flow rate B of the combustion assisting gas the multi-tube burner 1 (or the multi-tube burner 31) to appropriate ranges. Accordingly it is possible to deposit the glass microparticles on the outer periphery portion of the staring rod to a predetermined thickness in a short time.

Accordingly, it becomes possible to efficiently manufacture large-diameter glass rods without incurring a deteriorated quality, and accordingly, glass rods, such as optical fibers, can be provided at low cost.

### EXAMPLE

Herein, an example of the method for manufacturing a glass rod according to the present invention will be explained.

Using the multi-tube burner 1 shown in FIG. 1 as a burner, glass microparticles were synthesized using a column-shaped silica glass having an outer diameter of 200 mm as a starting rod, and the flow rate of SiCl₄ was set to 7.5 SLM, the flow rate of H₂ gas was set between 40 and 200 SLM, the flow rate of O₂ gas was set between 15 and 40 SLM, and the flow rate of Ar gas, which was used as a sealing gas, was set to 1 SLM.

Furthermore, the flow velocity of SiCl₄ was controlled by regulating the flow rate of a carrier gas (O₂ gas).

The glass microparticles were deposited on the outer periphery portion of the silica glass while shifting the multi-tube burner 1 from one end of the outer periphery portion of the silica glass to the other end in addition to shifting it along its central axis at a constant speed. In this example, in order not to cause irregularities on the surface on which the glass microparticles are deposited, the shifting speed of the multi-tube burner 1 and the flow rate and the flow velocity of each gas were controlled and the deposition rates under the different conditions were compared. It should be noted that the average deposition rate per unit time, which was obtained by dividing the weight of the deposited glass microparticles by the deposition time, was used as the deposition rate.

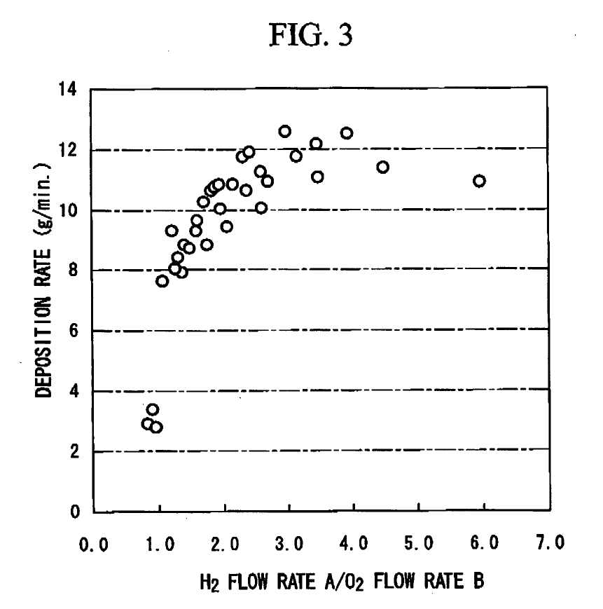

FIG. 3 is a graph showing the relationship between the ratio of the flow rate of H₂ gas A to the flow rate of O₂ gas B (A/B) and the deposition rate (g/minute).

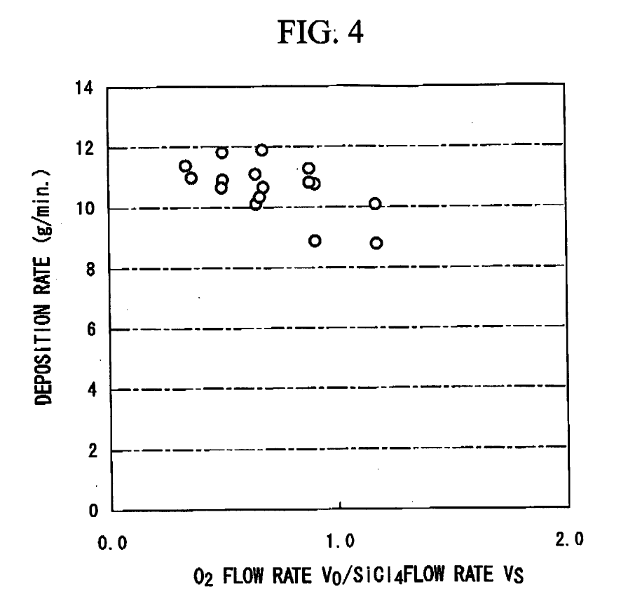

Furthermore, FIG. 4 is a graph showing the relationship between the ratio of the flow velocity of O₂ gas V_{O} to the flow velocity of SiCl₄ gas V_{S} (Vₒ/V_{S}) and the deposition rate (g/minute).

FIGS. 3 and 4 indicate that the maximum deposition rate was obtained when the ratio of the flow rate of H₂ gas A to the flow rate of O₂ gas B (A/B) satisfied 2.5≦A/B≦4.5 and when the ratio of the flow velocity of O₂ gas V_{O} to the flow velocity of SiCl₄ gas V_{S} (Vₒ/V_{S}) satisfied V_{O}/V_{S}≦0.9.

While exemplary embodiments of the invention have been described and illustrated above, it should be understood that these are examples of the invention and are not to be considered as limiting. Additions, omissions, substitutions, and other modifications can be made without deputing from the spirit or scope of the present invention. Accordingly, the invention is not to be considered as being limited by the foregoing description, and is only limited by the scope of the appended claims.

What is claimed is:

1. A method for manufacturing a glass rod, comprising:
introducing a glass source gas, an inert gas, a flammable gas, and a combustion assisting gas to a multi-be burner, the multi-tube burner comprising a first multi-tube, a plurality of nozzles provided surrounding the first multi-tube about a central axis of the first multi-tube, and a second multi-tube surrounding the nozzles, wherein the first multi-tube and the second multi-tube have a common central axis;
hydrolyzing or oxidizing the glass source mat a gas in a flame generated by a reaction between the flammable gas and the combustion assisting gas to synthesize glass microparticles; and
depositing the glass microparticles on an outer periphery portion of a stating rod in a radial direction to manufacturing the glass rod,
wherein a ratio of a flow rate A of the flammable gas to a flow rate B of the combustion assisting gas (A/B) satisfies the following inequality.
2.5≦A/B≦4.5

2. The method for manufacturing a glass rod according to claim 1, wherein a ratio of a flow velocity V_{O} of the combustion assisting gas to a flow velocity Vₛ of the glass source material gas (V_{O}/V_{S}) satisfies the following inequality:
V_{O}/V_{S}≦0.9.

3. The method for manufacturing a glass rod according to claim 1, further comprising treating the glass microparticles deposited in the radial direction on the outer periphery portion of the sing rod at a high temperature to form a glass body.

4. The method for manufacturing a glass rod according to claim 1, wherein the first multi-tube comprises concentric tubes or a plurality of elliptic-shaped tubes having a central axis.

5. The method for manufacturing a glass rod according to claim 1, wherein the plurality of nozzles are arranged in at lea one circle when viewing a plan view of a cross-section of the multi-tube burner, said at least one circle having a center tat matches the central axis of the first multi-tube.

6. The method for manufacturing a glass rod according to claim 1, wherein the first multi-tube comprises an inner tube having an outer diameter of between about 3 mm and 5 mm and an outer tube having an outer diameter of between about 6 mm and 8 mm in which the outer tube rounds the inner tube and has the same central axis as that of the inner tube.

7. The method for manufacturing a glass rod according to claim 6, wherein the inner tube and the outer tube are made of silica glass.

8. The method for manufacturing a glass rod according to claim 6, wherein the inner tube channels the glass source material gas and a space between the inner tube and the outer tube channels the inert gas.

9. The method for manufacturing a glass rod according to claim 1, wherein the plurality of nozzles are provided around the first multi-tube about the central axis of the first multi-tube.

10. The method for manufacturing a glass rod according to claim 9, wherein a first group of the plurality of nozzles are provided at regular intervals in the radial direction on a circumference having a radius of about 8 mm around the central axis of the first multi-tube, and a second group of the plurality of nozzles are provided at regular intervals in the radial direction on a circumference having a radius of about 12 mm.

11. The method for manufacturing a glass rod according to claim 1, wherein the plurality of nozzles are made of silica glass.

12. The method for manufacturing a glass rod according to claim 1, wherein the plurality of nozzles channel the combustion assisting gas.

13. The method for manufacturing a glass rod according to claim 1, wherein the second multi-tube comprises an inner tube having an outer diameter of between about 25 mm and 30 mm and an outer tube having an outer diameter of between about 30 mm and 35 mm which surrounds the inner tube and has the same central axis as that of the inner tube.

14. The method for manufacturing a glass rod according to cam 13, wherein the inner tube and the outer tube are made of silica glass.

15. The method for manufacturing a glass rod according to claim 13, wherein the inner tube channels the flammable gas and a space between the inner tube and the outer tube channels the inert gas.

16. The method for manufacturing a glass rod according to claim 9, wherein the plurality of nozzles are provided at regular intervals in the radial direction on a circumference having a radius of about 7 mm around the central axis of the first multi-tube.

17. The method for manufacturing a glass rod according to claim 1, wherein a ratio of a flow rate A of the flammable gas to a flow rate B of the combustion assisting gas (A/B) satisfies the following inequality:
3.0≦A/B≦4.0.

18. The method for manufacturing a glass rod according to claim 2, wherein a ratio of the flow velocity V_{O} of the combustion assisting gas to the flow velocity Vₛ of the glass source material gas (V_{O}/V_{S}) satisfies the following inequality:
V_{O}/V_{S}≦0.7.

19. The method for manufacturing a glass rod according to claim 2, wherein a ratio of the flow velocity V_{O} of the combustion assisting gas to the flow velocity Vₛ of the glass source material gas (V_{O}/V_{S}) satisfies the following inequality:
0.1≦V_{O}/V_{S}≦07.

20. The method for manufacturing a glass rod according to claim 1, in the glass microparticles are synthesized with the multi-tube burner having an outer diameter of 200 mm starting rod, and the flow rate of SiCl₄ as the glass source material gas was set to 7.5 SLM, the flow rate of H₂ gas as the flammable gas was set between 40 and 200 SLM, the flow rate of O₂ gas as the combustion assisting gas was set between 15 and 40 SLM, and the flow rate of Ar gas as the inert, or sealing, gas was set to 1 SLM.
